(19) United States
(12) Patent Application Publication
(10) Pub. No.: US 2008/0175178 A1
(43) Pub. Date: Jul. 24, 2008

(54) METHOD FOR CONNECTING A USER OF A MOBILE TELEPHONE NETWORK TO A DATA TRANSMISSION SERVICE

(75) Inventors: Bruno Patin, Fourqueux (FR); Thibaut Keraval, Linas (FR); David Cayuela, Montrouge (FR); Fanny Chabernaud, Vanves (FR)

Correspondence Address: HARNESS, DICKEY & PIERCE, P.L.C., P.O. BOX 828, BLOOMFIELD HILLS, MI, 48303, US

(73) Assignee: Bouygues Telecom

(21) Appl. No.: 12/015,843

(22) Filed: Jan. 17, 2008

(30) Foreign Application Priority Data
Jan. 18, 2007 (FR) 0752743

(51) Int. Cl. H04B 7/00

(52) U.S. Cl. 370/310

(57) ABSTRACT

The invention relates to a method for connecting a user of a mobile telephone network to a data transmission service, wherein a piece of access equipment generates a request for generating a data exchange context between a mobile terminal and a service platform by replacing a connection parameter transmitted by the mobile telephone terminal with a substitutional connection parameter, the first substitutional connection parameter being a connection parameter associated with the identifier of the subscriber in the user database.

### FIELD OF THE INVENTION

The invention relates to accessing data transmission services and to the use of these services via a mobile telephone network.

### STATE OF THE ART

Data transmission services are proposed by mobile telephone operators. The users have the possibility of accessing these services depending on subscriptions which they have subscribed with the operator.

In order to allow a user to access data transmission services and to use these services, a mobile telephone terminal has to be configured. In particular, the terminal must contain specific connection parameters which depend on the operator and on the user. These connection parameters are required in order to generate and use a data exchange context between the terminal and service platforms in the mobile telephone network.

Most mobile telephone terminals are initially configured by the terminal manufacturers for the operators. More specifically, a terminal is preconfigured for a specific offer proposed by the operator.

However an increasingly large portion of terminals (often called <<Universal Terminals>>) are not preconfigured by the manufacturer. This type of terminal has to be configured by the operator or by the user himself/herself.

For example, in order to access GPRS (General Packet Radio Service) or UMTS (Universal Mobile Telecommunication System) data transmission services, the mobile telephone terminals have to be configured in order to contain the following connection parameters:

an APN (Access Point Name) parameter identifying an access point of the network,

a VIP (Virtual IP address) parameter identifying a service platform of the operator,

a TCP (Transmission Control Protocol) or UDP (User Datagram Protocol) port parameter which, by convention, depends on the required service,

an URL (Uniform Resource Locator) connection address which designates a resource to which the mobile terminal has to be connected upon establishing the connection.

The APN parameter is specific to the mobile telephone operator. This parameter depends on services included in the subscription subscribed by the user.

The VIP, port and URL parameters depend on the service required by the user.

The configuration operation may be performed manually on all the terminals (by selecting the suitable options in the menu of the terminal and by entering the required parameters) or remotely on other compatible OTA (Over The Air) specific terminals. In all the cases, this configuration operation is different from one terminal to the other and relatively complex to be performed by a user.

Further, in the case when the terminal is not properly configured, the user would not be able to access data transmission services to which he/she has subscribed.

This situation in particular occurs in the case when the user has inserted his/her SIM card into a terminal which was initially configured for another operator or a user having subscribed to a different offer. In this case, the connection parameters recorded in the terminal do not actually necessarily correspond to the services to which the user has subscribed. Thus, the user receives a failure message at every attempt to connect to the data transmission services.

Document WO 2005/076690 A2 describes a method for configuring a mobile terminal according to which the mobile terminal sends to a help-portal a configuration request by using predefined APN and URL parameters. The help-portal authenticates the terminal and transmits a request to the provider server which configurates the terminal.

Such a method allows remote configuration of the terminal but requires specific operations from the user.

Document US 2004/0153548 A1 describes a method for dynamically reconfiguring a mobile terminal, the method being automatically triggered when a given event occurs or a given condition is met.

This method requires that the mobile terminal be specifically programmed in order to perform the different reconfiguration steps.

Document WO 2006/077555 A1 describes a connection method to a data transmission service according to which a gateway server transmits to an authentication, authorization and accounting server (AAA server) an access request, the access request including an APN parameter and an identity parameter of the mobile terminal. The server AAA determines whether the mobile terminal is authorized to access the service with the APN parameter of the access request and if this is not the case, the gateway server selects a substitutional APN parameter in a list of APN parameters.

Document WO 2005/071982 A1 describes a method for connecting to a GPRS (General Packet Radio Services) service according to which the SGSN (Serving GPRS Support Node) node determines whether the connection request of the mobile terminal contains an APN parameter. If this is not the case or if the APN parameter is erroneous, the SGSN determines a substitutional APN.

The substitutional APN parameter allows the mobile terminal to access the data transmission service even if the mobile terminal is not properly configured for this purpose.

Such a method allows transparent access to the data transmission service without requiring a reconfiguration of the mobile terminal.

This method provides a reduction in the connection failures due to an erroneous configuration of the mobile terminal.

However, in these methods, the substitutional APN parameter is a generic APN parameter, which does not take into account the profile of the user. More specifically, this parameter does not necessarily correspond to the services which have been subscribed by the user with his/her subscription.

Moreover, with such methods, there exists a risk that fraudulent users may access data transmission services, by means of a substitutional APN parameter without having paid rights of access to these services beforehand.

### SUMMARY OF THE INVENTION

An object of the invention is to allow a user to access data transmission services to which he/she has subscribed, even if the mobile terminal which he/she uses is not configured for this purpose.

This problem is solved within the scope of the present invention by means of a method for connecting a user of a mobile telephone network to a data transmission service, comprising steps according to which:

a mobile telephone terminal transmits to a first piece of equipment for accessing a data transmission network, a request for connecting to the service, the connection request including at least one identifier of the user and a first connection parameter,

the first piece of access equipment checks whether the identifier is present in a user database containing identifiers of users of the network and connection parameters and in which certain users identifiers are associated with at least one connection parameter,

the first piece of access equipment generates a request for generating a data exchange context between the mobile terminal and a service platform by replacing the first connection parameter transmitted by the mobile telephone terminal with a first substitutional connection parameter, the first substitutional connection parameter being a connection parameter associated with the identifier of the subscriber in the user database.

With the step for checking the identifier of the user, it is possible to search for a configuration parameter depending on the profile of the user. Thus, the user may have access to customized services, transparently.

The method may further comprise a step according to which, in the case when no connection parameter is associated with the sought identifier, the piece of access equipment transmits to the mobile terminal a connection failure message.

In an embodiment of the invention, the first connection parameter is an APN parameter.

The method may further comprise steps according to which:

the mobile terminal transmits to a second piece of access equipment a traffic data request containing a second connection parameter specific to the data transmission service,

the second piece of access equipment converts the second parameter into a corrected parameter,

the second piece of access equipment transmits a data traffic request to a gateway server associated with the corrected parameter.

In an embodiment of the invention, the second piece of equipment queries a correspondence table containing corrected parameters for converting the second parameter.

In an embodiment of the invention, the second parameter is a VIP address parameter designating a gateway server

In an embodiment of the invention, the conversion step takes into account a parameter indicating the nature of a data flow to be exchanged.

In an embodiment of the invention, the parameter indicating the nature of a data flow to be exchanged is a port parameter.

The method may further comprise steps according to which:

the gateway server controls a third address parameter designating a resource towards which the connection should be established, the third parameter being contained in the connection request,

the gateway server converts the third address parameter into a substitutional address parameter,

the gateway server transmits a connection request to the substitutional address.

In an embodiment of the invention, during the checking step, the gateway server determines whether the address parameter is present among a list of predetermined address parameters.

The method may further comprise a step according to which, if the third address parameter is present in the address parameter list, the gateway server searches for a substitutional address parameter in a correspondence table.

The invention also relates to a piece of access equipment for connecting a user of a mobile telephone network to a data transmission service, the piece of equipment being programmed in order to:

receive a connection request to the service transmitted by a mobile terminal, the connection request including at least one identifier of the user and a first connection parameter,

check whether the identifier is present in a user database containing identifiers of users of the network and connection parameters and in which certain user identifiers are associated with at least one connection parameter,

generate a request for generating a data exchange context between the mobile terminal and a service platform by replacing the first connection parameter transmitted by the mobile telephone terminal with a first substitutional connection parameter, the first substitutional connection parameter being a connection parameter associated with the identifier of the subscriber in the user database.

### PRESENTATION OF THE FIGURES

Other features and advantages will become further apparent from the description which follows, which is purely illustrative and non-limiting and should be read with reference to the appended drawings, among which:

FIG. 1 schematically illustrates access equipment to GPRS data transmission services of a mobile telephone network,

FIG. 2 schematically illustrates the steps of a first phase of a method for connecting to a GPRS data transmission service, according to a possible embodiment of the invention,

FIG. 3 schematically illustrates the steps of a second phase of the method,

FIG. 4 schematically illustrates the steps of a third phase of the method.

### DETAILED DESCRIPTION OF AN EMBODIMENT

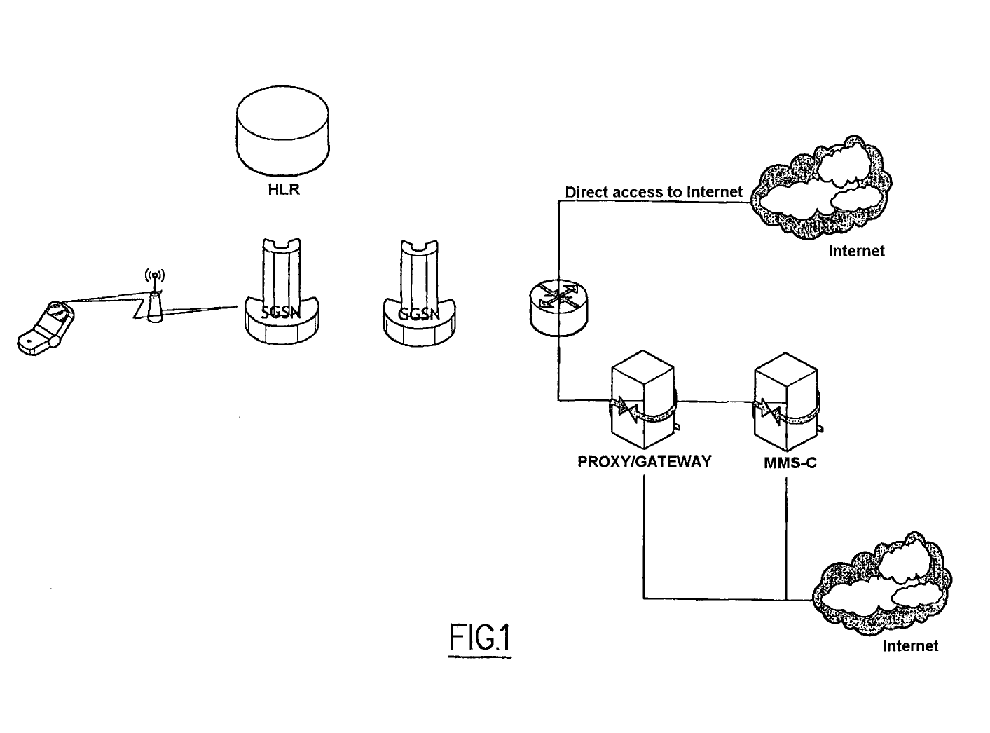

In FIG. 1, the mobile telephone network comprises an SGSN (Serving GPRS Support Node) server, a HLR (Home Location Register) register, a GGSN (Gateway GPRS Support Node) server, a platform for connecting to an Internet network and to a service proxy/gateway server, one or more proxy/gateway servers and an MMS-C (MultiMedia Messaging Service Center) server.

The SGSN server is a server which manages subscribers having access to GPRS services in a given cell of the mobile telephone network. The SGSN server is the piece of equipment at which a mobile terminal is attached and recorded. The SGSN server is capable of sending back an IP address to the mobile terminal and of routing the exchange data between the mobile terminal and the GPRS service (notably towards a GGSN server).

The GGSN server is a gateway server with which data may be forwarded between the (GPRS/UMTS) mobile telephone network and another network.

The HLR register is a database which contains information required for managing subscribers of the mobile telephone network. This register notably contains information identifying the subscribers, information relative to their localization as well as information relative to the services subscribed by the subscribers.

A proxy/gateway server is typically a transparent or WAP or IMode gateway.

Each proxy/gateway server is capable of providing a data transmission service, such as for example an Internet, Imode or WAP browser service, or a service for sending and receiving MMS messages.

The MMS-C server is a telephone exchange responsible for checking whether MMS type calls (including multimedia contents, such as a photograph or a video) may be received and treated by the recipient mobile terminals.

When a mobile terminal transmits to the mobile telephone network a request for connecting to a data transmission service, a connection procedure is triggered. This procedure comprises several phases, each phase involving specific equipment of the network.

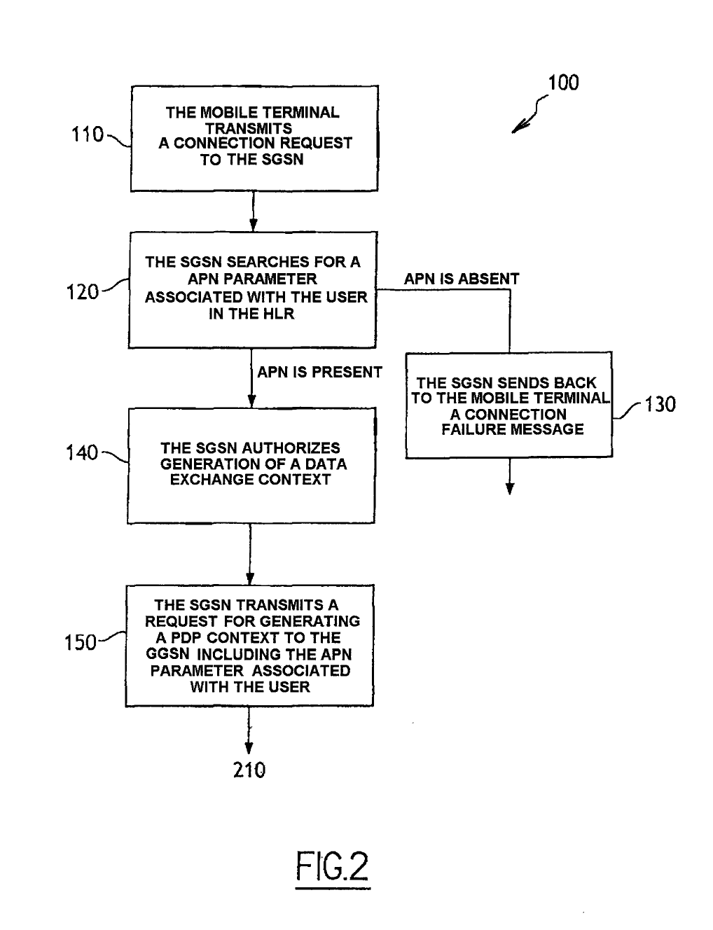

FIG. 2 illustrates a first phase 100 of a connection method.

According to a first step 110, the mobile terminal transmits a request for connecting to the SGSN server. The connection request contains a parameter identifying the user on the one hand and a connection parameter on the other hand, required for establishing access to the data transmission service.

The parameter identifying the user is for example the IMSI (International Mobile Subscriber Identity) number of the user.

The connection parameter is notably an APN (Access Point Name) parameter identifying an access point of the network. The APN parameters are specific to the mobile telephone operators.

According to a second step 120, the SGSN server checks the APN parameter associated with the request.

For this purpose, the SGSN server queries the HLR register which contains identifiers of users of the network and APN parameters, each identifier being associated with one or more APN parameters, depending on the subscription subscribed by the user.

The SGSN server searches in the HLR register for the IMSI number of the user and determines if at least one APN parameter is associated with the IMSI number.

If no APN parameter is present in the HLR register, this means that the user has not subscribed to the data transmission services. In this case, according to a third step 130, the SGSN server sends back to the mobile terminal a failure message indicating that connection is impossible.

If an APN parameter associated with the user is present in the HLR register, according to a fourth step 140, the SGSN server authorizes generation of a data exchange context. The SGSN server transmits to the mobile terminal a message for accepting the connection.

According to a fifth step 150, the SGSN server transmits to the GGSN server a request for generating a PDP (Packet Data Protocol) context for exchanging data.

The SGSN server generates the request for generating a context by using the APN parameter associated with the user in the HLR register.

In other words, the SGSN server has replaced the APN parameter initially transmitted by the mobile terminal with a substitutional APN parameter which is the APN parameter associated with the user in the HLR register.

The first phase 100 allows the user to trigger a procedure for accessing the data transmission service, even if the APN parameter recorded in his/her mobile terminal is erroneous.

Because the SGSN server performs a substitution of the APN parameter, no reconfiguration of the mobile terminal is necessary.

Further, the substitutional APN is determined depending on the identity of the user. Thus, the user may access a customized set of data transmission services, this set depending on the subscription to which he/she has subscribed.

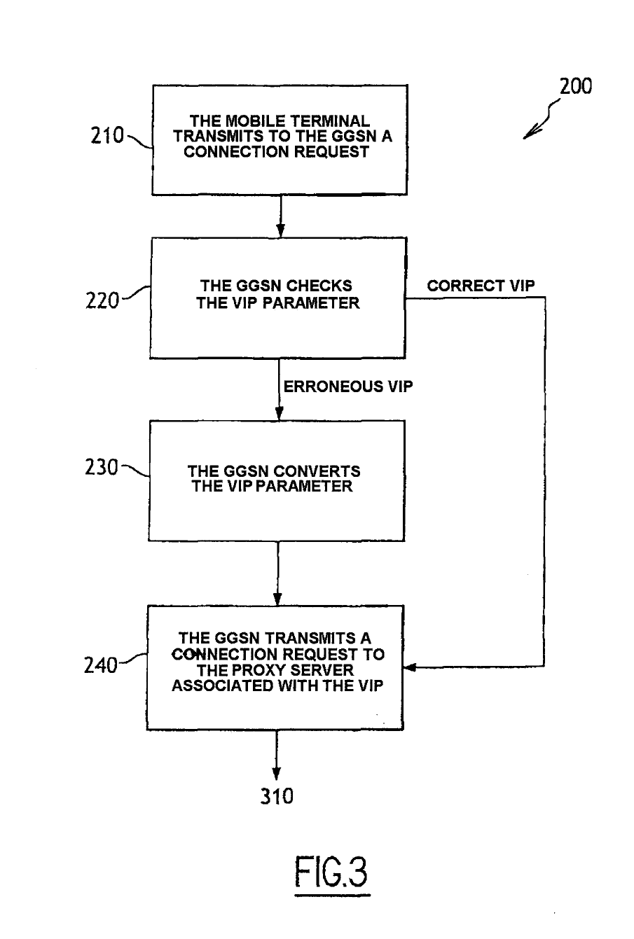

FIG. 3 illustrates a second phase 200 of the connection method.

The mobile terminal receives the connection acceptance message transmitted by the SGSN server.

According to a first step 210, the mobile terminal transmits to the GGSN, a request for traffic data containing connection parameters specific to the required data transmission service. These parameters include pre-recorded VIP, port and URL parameters in the mobile terminal.

According to a second step 220, the GGSN server checks the VIP parameter. The VIP parameter is specific to each mobile telephone operator. The GGSN server determines whether the VIP parameter is correct (i.e. that it is accessible by the GGSN of the operator with the offer of services to which the user has subscribed).

For this purpose, the GGSN server may perform an operation for testing connection towards a proxy/gateway server associated with the VIP parameter.

If the GGSN server determines that the VIP parameter is correct, then the GGSN server directly performs a fourth step 240 by transmitting a request for connection to the proxy/gateway server associated with the VIP address.

If the GGSN server determines that the VIP parameter is erroneous (i.e. that the GGSN server is not capable or not authorized to contact the VIP address), then the GGSN server performs a third step 230, according to which it converts the VIP parameter into a corrected VIP parameter.

The conversion may take into account the port parameter (which is independent of the operator). Actually, this parameter provides an indication on the type of data flow which should be established.

For this purpose, the GGSN server refers to a correspondence table and performs a NAT (Network Address Translation) conversion operation to the corrected VIP parameter.

According to the fourth step 240, the GGSN server transmits a request for data traffic to the proxy/gateway server associated with the corrected VIP parameter.

The second phase 200 allows a connection to be established with a proxy/gateway server of the operator, even if the mobile terminal is not correctly parameterized for this purpose.

For instance, this is the case when the mobile terminal is configured with a VIP parameter designating a proxy/gateway server of a mobile telephone operator other than the one at which the user has subscribed a subscription.

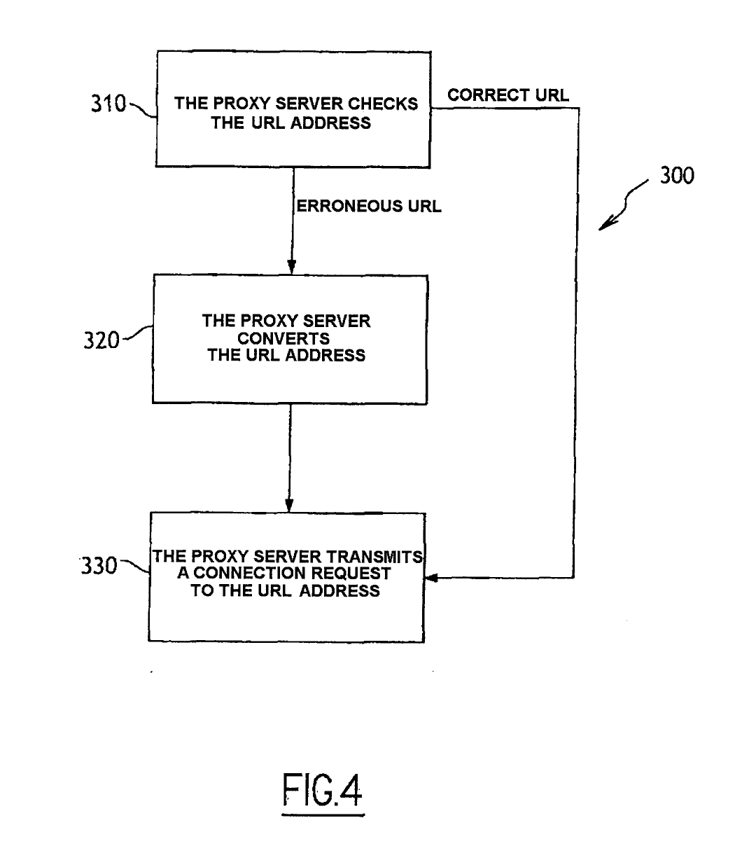

FIG. 4 illustrates a third phase 300 of the connection method.

According to a first step 310, the proxy/gateway server checks the sought URL address.

The URL address is a default URL address pre-recorded in the mobile terminal. The URL address designates a resource to which the mobile terminal should be connected during establishment of the connection. However, the user may, after establishing the connection, specify other URL addresses in order to connect the mobile terminal to other resources.

The proxy/gateway server determines whether the default URL address transmitted by the mobile terminal is present among a list of predetermined URL addresses.

This list contains URL addresses designating resources provided by mobile telephone operators different from the operator at which the user has subscribed a subscription.

If the URL address is not present in the list of predetermined URL addresses, the proxy/gateway server directly switches to step 330 and establishes a connection between the mobile terminal and the sought URL address.

If the sought URL address is present in the list of predetermined URL addresses, according to a second step 320, the proxy/gateway server converts the URL address into a substitutional URL address. For this purpose, the proxy/gateway server searches for a substitutional URL address in a correspondence table.

According to a third step 330, the proxy/gateway server establishes a connection to the substitutional URL address.

This third phase 300 allows the URL addresses to be filtered and the request for connection to URL addresses accepted by the mobile telephone operator (for example to an URL address corresponding to the access gateway of the operator) to be redirected.

1. A method for connecting a user of a mobile telephone network to a data transmission service, comprising steps according to which:
a mobile telephone terminal transmits to a first piece of equipment for accessing a data transmission network, a request for connection to the service, the connection request including at least one identifier of the user and a first connection parameter,
the first piece of access equipment checks whether the identifier is present in a user database containing identifiers of users of the network and connection parameters and in which certain user identifiers are associated with at least connection parameter,
the first piece of access equipment generates a request for generating a data exchange context between the mobile terminal and a service platform by replacing the first connection parameter transmitted by the mobile telephone terminal with a first substitutional connection parameter, the first substitutional connection parameter being a connection parameter associated with the identifier of the subscriber in the user database.

2. The method according to claim 1, comprising a step according to which, in the case when no connection parameter is associated with the sought identifier, the access equipment transmits a connection failure message to the mobile terminal.

3. The method according to claim 1, wherein the first connection parameter is an APN parameter.

4. The method according to claim 1, comprising steps according to which:
the mobile terminal transmits to a second piece of access equipment a request for traffic data containing a second connection parameter specific to the data transmission service,
the second piece of access equipment converts the second parameter into a corrected parameter,
the second piece of access equipment transmits a request for traffic data to a gateway server associated with the corrected parameter.

5. The method according to claim 4, wherein the second piece of equipment queries a correspondence table containing corrected parameters for converting the second parameter.

6. The method according to claim 4, wherein the second parameter is a VIP address parameter designating a gateway server.

7. The method according to claim 4, wherein the conversion step takes into account a parameter indicating the nature of a flow of data to be exchanged.

8. The method according to claim 7, wherein the parameter indicating the nature of a flow of data to be exchanged is a port parameter.

9. The method according to claim 4, comprising steps according to which:
the gateway server checks a third address parameter designating a resource towards which the connection should be established, the third parameter being contained in the connection request,
the gateway server converts the third address parameter into a substitutional address parameter,
the gateway server transmits a connection request to the substitutional address.

10. The method according to claim 9, during the checking step, the gateway server determines whether the address parameter is present among a list of predetermined address parameters.

11. The method according to claim 10, wherein, if the third address parameter is present in the list of address parameters, the gateway server searches for a substitutional address parameter in a correspondence table.

12. Access equipment for connecting a user of a mobile telephone network to a data transmission service, the equipment being programmed in order to:
receive a request for connection to the service transmitted by a mobile terminal, the connection request including at least one identifier of the user and a first connection parameter,
check whether the identifier is present in a user database containing identifiers of users of the network and connection parameters and wherein certain user identifiers are associated with at least one connection parameter,
generate a request for generating a data exchange context between the mobile terminal and a service platform by replacing the first connection parameter transmitted by the mobile telephone terminal with a first substitutional connection parameter, the first substitutional connection parameter being a connection parameter associated with the identifier of the subscriber in the user database.
